(19) United States
(12) Patent Application Publication
(10) Pub. No.: US 2001/0043824 A1
(43) Pub. Date: Nov. 22, 2001

(54) Method and apparatus for setting register in a multicolor printing machine

(75) Inventors: Thomas Henderson, Rochester, NY (US); Christopher Liston, Rochester, NY (US); Patrick Metzler, Gettorf (DE); Karlheinz Walter Peter, Molfsee (DE)

Correspondence Address: Lawrence P. Kessler, Patent Department, NexPress Solutions LLC, 1447 St. Paul Street, Rochester, NY, 14653-7103, US

(73) Assignee: NexPress Solutions LLC

(21) Appl. No.: 09/858,111

(22) Filed: May 15, 2001

Related U.S. Application Data
(60) Provisional application No. 60/204,931, filed on May 17, 2000.

(30) Foreign Application Priority Data
May 17, 2000 (DE) 100 24 199.9

(51) Int. Cl. G03G 15/01

(52) U.S. Cl. 399/301

(57) ABSTRACT

The invention relates to a method and apparatus for setting register in a multicolor printing machine (1) having a number of items of equipment (2, 2′, . . . ) for the digital production of color separations (3, 3′, . . . ), the actions of setting up and combining the color separations (3, 3′, . . . ) being controlled, in order to set the register, in such a way that in-register prints are achieved.

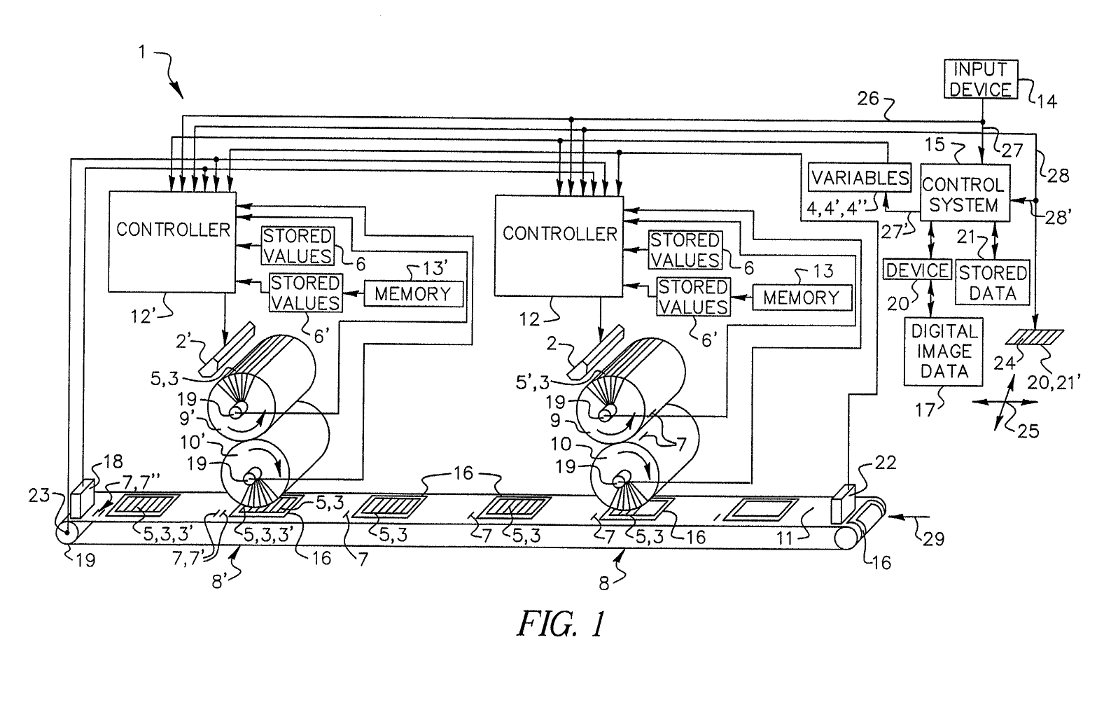

The invention is based on the object of developing the method and apparatus in such a way that a change in the toner profile no longer leads to a register fault, not even temporarily.

According to the invention, the object is achieved in that in the event of a change in the toner profile (5, 5′), the influence of the toner profile on the register is taken into account, by means of available influencing variables (4, 4′, . . . ) directly as the change is implemented.

The invention relates to a method for setting register in a multicolor printing machine having a number of items of equipment for the digital production of color separations, the actions of setting up and combining the color separations being controlled in order to set the register in such a way that in-register prints are achieved.

The invention further relates to apparatus for implementing the method with a multicolor printing machine having a number of items of equipment for the digital production of color separations, at- least one controller performing a register setting, in which the actions of producing and combining the color separations are controlled, in order to achieve in-register prints.

Printing colored illustrations, in particular colored images, is carried out by a number of color separations being printed over one another. These are generally the colors yellow, magenta and cyan as well as black. If required, special colors are added. By means of overprinting these colors, all color combinations can be achieved, the quality of the prints depending significantly on the in-register overprinting of the color separations. In the case of digital printing processes, for example electrostatic printing processes, the maintenance of the register of the overprint is achieved by the image production devices being controlled in such a way that the color separations meet one another in-register when they are transferred to a printing substrate.

A method and apparatus of the type mentioned at the beginning are disclosed in U.S. Pat. No. 5,715,498. There, the correction of register faults by means of printing and detecting register marks is proposed. The drawback with this technical solution is that in the event of a change in the toner profile as a result of a change in the printed page, counteractive control is only ever possible for the following page, since the effect of the change in an influencing variable is registered only when it has already caused a register fault. As a result, proofs are needed, and time is lost, which is often uneconomic in the case of small jobs and, therefore, not acceptable. Printing individual different printed pages economically is not possible in this way.

The invention is, therefore, based on the object of developing a method and apparatus of the type mentioned at the beginning in such a way that a change in the toner profile resulting from a change in the printed page no longer leads to a register fault, not even temporarily.

According to the invention, the object is achieved in relation to the method in that in the event of a change in the toner profile, the influence of the toner profile on the register is taken into account, by means of available influencing variables, directly as the change is implemented.

According to the invention, the object is achieved in relation to the apparatus in that the at least one controller is designed in such a way that in the event of a change in the toner profile, it takes into account the influence of the toner profile on the register, by means of available influencing variables, directly as the change is implemented.

The advantage of the invention resides in the fact that, in the event of a change in the toner profile when a printed page is changed, a register fault, which is imminent, as a result is counteracted without any delay. It is no longer necessary to wait until the changed toner profile results in a register fault that can be detected with the aid of register marks. Instead, it is possible that directly as the printed page is changed, counteractive control can be carried out and, as a result, the occurrence of a register fault can be prevented from the outset so that proofs of prints and/or register marks are generally not necessary. This is of economic significance precisely in the case of small jobs, since machine time can often be saved, and printing substrates as well. With regard to the printing of printed pages with changing content, the result is that it is possible for the first time to achieve a standard of quality which was previously not possible in this important field of use of printing machines with digital image production.

As a result of the measure according to the invention, a register setting of the known type can be optimized with the effect that, in the event of changes in the toner profile, it does not “get out of hand” initially in order to be corrected again later, but rather that the register setting remains within the range of tolerable fluctuations, so that during a change in the toner profile, it is possible to continue to print without interruption. At the same time, the invention does not exclude taking into account other influencing variables, if these have an influence on the register.

A development of the method provides that, in the event of a register correction because of a change in the toner profile, the retroactive influence of the toner profile of the printed pages which have gone before but are still in the printing process on the register of the new printed page already in the printing process is taken into account. In this way, the maintenance of register in the prints in the event of a change to a printed page with a different image content is even better ensured. The printing machine can continue to print without any interruption even if, between the actions of setting up two color separations, the change in the printed page takes place in such a way that the new color separation is already being set up while the preceding color separation from the previous printed page has not yet or not yet completely been transferred to the printing substrate. The maintenance of register is, therefore, ensured to a high extent, even in this overlap region between two printed pages, and any mutual influence is compensated for. As a result, the economicalness is increased significantly, and the printing of printed pages with changing content at high quality is possible. With regard to the apparatus, this is achieved by the at least one controller being designed in such a way that, in the event of a register correction caused by a change in the toner profile, the retroactive influence of the toner profile of the printed pages which have gone before but are still in the printing process on the register of the new printed page which is already in the printing process is taken into account by the controller.

Since the change in a printed page runs through the machine from one printing unit to the next and also, within a printing unit, runs through the printing unit on the path from production as far as transfer to the printing substrate, in this case these various machine configurations must be taken into account by means of variable influencing variables for each printing unit.

The influencing variables of the toner profiles can be taken into account on the basis of stored values based on experience, by means of manual input, by evaluating digital image data or by means of automatic detection of the toner profiles. With regard to the apparatus, provision can be made for it to be equipped with at least one memory, which contains stored values based on experience of influencing variables of various toner profiles, the at least one controller controlling the actions of setting up and combining the color separations on the basis of these values based on experience. However, it is also possible to equip the apparatus with an input device, via which the influencing variables of various toner profiles to be taken into account can be activated manually. A further alternative consists in providing a printing-machine control system, which contains stored data on printed pages or the data from a number of print jobs, and takes into account the influencing variables of various toner profiles on the basis of this data. A device for the automatic detection of the influencing variables of various toner profiles is also possible.

An expedient configuration with regard to the method provides for the influencing variables of various toner profiles to be determined in accordance with the extent of area coverage of the total image area by the color separations. In this way, it is not necessary to re-measure the influencing variables for each printed page. Instead it is sufficient to determine the extent of area coverage of the total image area for each color separation and, either to calculate the influencing variables from this data for all the printing units, or to determine them from a prepared tabular file. With regard to the apparatus, provision is then made for the device for determining the influencing variables to detect the toner profiles in accordance with the extent of area coverage of the total image area by the color separations. In this case, provision can be made for the device to be designed to detect the influencing variables from the digital image data. In order to reduce the outlay on computing, provision can be made for areas with a number of image pixels to be combined during the evaluation of the digital image data.

Essentially, the invention pursues the objective of serving to correct a register control system that is provided. The latter can be designed in such a way that it is based on the detection of register marks, which are printed by the individual printing units. In this case, the invention provides that this correction is made before a change in the toner profile can have any influence on the register marks. The apparatus then has to be configured in such a way that the at least one controller is designed in such a way that it controls the register by means of detecting register marks which are printed by the individual printing units and detected by a register sensor, and takes into account the influencing variables of the toner profiles as correction factors, the correction being made before a change in the toner profile can have any influence on the register.

However, the invention can also serve to correct a register control system, which is based on detecting the positions of the elements that carry the color separations and substrate. With regard to the apparatus, provision is then made for the at least one controller to be designed in such a way that it controls the register by means of detecting the positions of the elements that carry the color separations and substrate by means of position detecting elements, and takes into account the influencing variables of the toner profiles as correction factors. The position detecting elements can be rotary encoders, for example.

Provision can, of course, be made for further influencing variables which have an influence on the register to be taken into account when setting the register. These may be, for example, paper grades, paper thicknesses or other influencing variables. With regard to the apparatus, at least one controller must then be provided which is designed to take these further influencing variables into account.

The invention will be explained below using an exemplary embodiment illustrated in the FIGURE.

The FIGURE illustrates a multicolor printing machine 1 having two printing units 8, 8′. This is a simplification; normally there are four or more printing units 8, 8′, . These must be imagined as being added.

The multicolor printing machine 1 has equipment 2, 2′, . . . for the digital production of color separations 3, 3′ . . . on image cylinders 9, 9′, . . . . By means of this equipment 2, 2′, . . . a new image is produced for each print, as a result of which such a machine is suitable for prints in which the image content and therefore the toner profile changes from one page to the next. This is the main field of use of the invention.

Each printing unit 8, 8′, . . . has an image cylinder 9, 9′ . . . and an image transfer cylinder 10, 10′ . . . , the latter transferring the color separations 3, 3′, . . . to the printing substrates 16. These are transported through the printing machine 1 in the direction of the arrow 29 by a printing substrate carrier 11. In order that the color separations 3, 3′, . . . are produced by the equipment 2, 2′, . . . in such a way that they are transferred in-register to the printing substrates 16, controllers 12, 12′, . . . are provided, which control the equipment 2, 2′, . . . in such a way that image starts, lines or areas of the color separations 3, 3′, . . . are coordinated with one another.

Such controllers 12, 12′, . . . can be configured in such a way that each printing unit 8, 8′, . . . prints a register mark 7, 7′, . . . and these register marks 7, 7′, . . . are detected by a register sensor 18. The evaluation of the position of the register marks 7, 7′, . . . then gives the relationship of the color separations 3, 3′, . . . , and in the event of deviation a correction can be made such that the color separations 3, 3′, . . . are transferred in-register to the printing substrates 16.

A further possibility is for the image cylinders 9, 9′, . . . and, if appropriate, the image transfer cylinders 10, 10, . . . to be equipped with position detecting elements 19, for example, with rotary encoders. A further rotary encoder 19 is provided on the drive roller 23 of the printing substrate carrier 11. By means of these position detection elements 19, the positions of the cylinders 9, 9′, . . . ; 10, 10′, . . . and of the printing substrate carrier 11 can be assigned to one another, and this makes it possible to detect and correct positional shifts, in order that accurate in-register printing can be carried out.

Although it is possible, by detecting the register marks 7, 7′, . . . and by detecting the position, to detect and correct a change in the register as a result of a change in the toner profiles, this has the disadvantage that the effect of the change in the influencing variables 4, 4′ . . . of various toner profiles must already have occurred in order to be able to detect and correct it. However, this means that ongoing continuous printing between a preceding printed page 5 and a new printed page 5′ with a different image content and therefore a different toner profile is not possible.

The invention therefore provides for the at least one controller 12, 12′, . . . to be designed in such a way that, with the aid of available influencing variables 4, 4′, . . . of toner profiles, it takes into account their influence on the register directly.

One option for taking influencing variables 4, 4′, . . . of 20 various profiles into account is for data on printed pages 5, 5′ to be input at an input device 14 and this data to be transmitted onward, via a connection 26, from the input device 14 to the controllers 12, 12′, . . . , the controllers 12, 12′, . . . calling up stored values 6, 6′, . . . based on experience for various toner profiles from memories 13, 13′, . . . on the basis of this data on the printed pages 5, 5′,. . . and, as a result, obtaining the influencing variables 4, 4′, . . . of the same toner profiles, which are taken into account by the controllers 12, 12′, . . . without any time delay. In this way, the equipment 2, 2′, . . . is capable of performing the digital production of color separations 3, 3′, . . . in-register without interruption.

Here, values 6, 6′, . . . based on experience for various toner profiles can be determined from the extent of area coverage of the total area of an image 24 by the individual color separations 3, 3′ . . . . These values 6, 6′, . . . based on experience and/or data for the individual color separations 3, 3′, . . . for calculating the influencing variables 4, 4′, . . . for the individual printing units 8, 8′, . . . can be stored in the memories 13, 13′ . . . . In order to reduce the amount of data with respect to the combinations of the individual area coverages of the color separations 3, 3′, . . . , the controllers 12, 12′, . . . can perform the necessary computing operations. The latter is primarily advantageous when the retroactive influence of a preceding printed page 5 on the following printed page 5′ is to be taken into account or if the retroactive influence of preceding printed pages on the following printed pages is to be taken into account, which is not illustrated for reasons of simplification. This is illustrated by the fact that the image cylinder 9 has already been set with the color separation 3 of the new printed page 5′ by the equipment 2 while the color separation 3, 3′, . . . of the preceding printed page 5 is still being processed on the other image cylinder 9′. If the color separation 3 of the new printed page 5′ has a different area coverage of the toner application than the color separation 3 of the preceding printed page 5, the latter color separation determines the coefficient of friction between the image cylinder 9 and the image transfer cylinder 10. This has to be taken into account when setting the image on the image cylinder 9 with the color separation 3 of the new printed page 5′. If the color separation 3 of the new printed page 5′ is then transferred to the image transfer cylinder 10, then the relationships of this new printed page 5′ determine the coefficient of friction and, therefore, the positional relationships of the image cylinder 9 with the image transfer cylinder 10. This results in the influencing variables 4, 4′, . . . as variables which must be assigned to the respective machine configuration. If printed pages 5, 5′, . . . with different toner profiles are printed one after another, then, in the case of a machine with four printing units 8, 8′, . . . , four different printed pages 5, 5′, . . . are processed at the same time, and their influence on one another must be taken into account. In a corresponding way, the circumstances just described have to be taken into account during the transfers to the printing substrates 16.

However, the determination just described of the influencing variables 4, 4′, . . . , including the retroactive effect of the preceding printed page 5′ or printed pages is already a development of the invention which is important for printing printed pages 21 with various image contents or for extremely small series. Even without the latter, it is advantageous for other intended purposes if a change in a toner profile can be taken into account immediately and not just as a result of an effect which it has already had on the register. The above-mentioned determination of the influencing variables 4, 4′, . . . of the toner profiles, also taking into account the mutual retroactive effects, is, however, independent of the manner in which the influencing variables 4, 4′, . . . of the toner profiles are made available.

With regard to the determination of the influencing variables 4, 4′, . . . it is possible for data on printed pages 5, 5′ to be provided to the printing-machine control system 15 via the input device 14 and a connection 27, and for said control system to call up the influencing variables 4, 4′, . . . to be taken into account for various toner profiles via input and/or stored data 17 or 21. The particular advantage of this embodiment resides in the fact that virtually everything takes place by the data processing route, it being possible, for example, for toner profiles to be obtained readily from stored digital image data 17. The influencing variables 4, 4′, . . . which the printing-machine control system 15 receives from the stored data 21 and/or 17 are transmitted onward to the controllers 12, 12′, . . . with the aid of a connection 27′. Data 17, 21 of this type may relate to a number of printed pages 5, 5′, . . . or the printed pages 5, 5′, . . . from a number of print jobs.

The influencing variables 4, 4′, . . . of various toner profiles can be determined for example by automatically detecting the toner profiles. Thus, a device 20 can be designed in such a way that it determines the toner profiles from digital image data 17. However, it is also possible to provide the device 20 with a densitometer 20′, in order to determine the influencing variables 4, 4′, . . . or data for calculating the same from the images 24 to be printed. For this purpose, the densitometer 20′ registers the entire image 24, which for this purpose has to be moved in accordance with the arrow 25. The influencing variables 4, 4′, . . . determined, or data for calculating the same, can be fed to the controllers 12, 12′, . . . via a connection 28. The controllers 12, 12′, . . . could also be designed in such a way that they determine the influencing variables 4, 4′, . . . , if necessary with the aid of values 6, 6′, . . . based on experience stored in the memories 13, 13′, .

A further alternative is for a device 20 to provide the data determined to the printing-machine control system 15, as illustrated, for example, by the connection 28′. On the basis of this data, the printing-machine control system 15 can also link the influencing variables 4, 4′, . . . of various toner profiles with other influencing variables, in order to calculate common correction values. As a result, for example the paper grade, the paper thickness or other influencing variables can also be included in the calculation of the register. The printing machine control system 15 then forwards influencing variables 4, 4′, . . . to the controllers 12, 12′, . . . via the connection 27′, it being possible for these to be the influencing variables 4, 4′, . . . of various toner profiles or else influencing variables which also simultaneously take into account the other influences mentioned.

In order that the controllers 12, 12′, . . . can assign the color separations 3, 3′, . . . to the printing substrates 16, a sensor 22 for detecting printing substrates 16 must also be arranged at the start of the printing substrate carrier 11, and informs the controllers 12, 12′, . . . as to the position in which a printing substrate 16 is located on the printing substrate carrier 11.

The list in the exemplary embodiment of the figure is not final, and it is not necessary for all the alternatives illustrated to be provided in the machine, for example, it is also possible to provide only one input device 14 with a connection 26 to the controller s 12, 12′, . . . , which call up the stored values 6, 6′, . . . based on experience for various toner profiles. Alternatively, provision may be made for only the influencing variables 4, 4′, . . . to be taken from stored data 21 and/or 17 by the printing-machine control system 15. This can be done automatically or via an input at the input device 14. A further possibility, which is likewise possible separately, is to detect influencing variables by means of the device 20, 20′ described.

However, it is most expedient to provide all the possibilities in the manner illustrated in one machine, in order to be able to select one or the other alternative on the basis of the data available or the critical influencing variables during the operation of the machine. However, the configurations are only exemplary, other methods for obtaining influencing variables and processing the same are conceivable.

### Parts List

1 Multicolor printing machine

2, 2′, . . . Equipment for the digital production of color separations

3, 3′, . . . Color separations

4, 4′, . . . Influencing variables of various toner profiles

4 Toner profiles of the preceding printed page

4′ Toner profile of the following printed page

5, 5′ Printed pages

5 Preceding printed page

5′ Following printed page

6, 6′, . . . Stored values based on experience for various toner profiles

7, 7′, . . . Register marks

8, 8′, . . . Printing units

9, 9′, . . . Image cylinders

10, 10′, . . . Image transfer cylinders

11 Printing substrate carrier

12, 12′, . . . Controller to achieve in-register prints (for example assigned to the printing units)

13, 13′, . . . Memories

14 Input device

15 Printing machine control system

16 Printing substrates

17 Digital image data

18 Register sensor

19 Position detecting element, for example rotary encoder

20 Device for determining the influencing variables of the toner profiles

20′ Densitometer

21 Data from print jobs

22 Sensor for detecting printing substrates

23 Drive roller of the carrier for printing substrates

24 Image

25 Arrow: movement of the image under the device 20, for example under the densitometer 20′

26 Connection between input device and controllers

27 Connection between input device and printing machine control system

27′ Connection between printing-machine control system and controllers (assigned to the printing units)

28 Connection between device 20, 20′ and controllers (assigned to the printing units)

28′ Connection between device 20, 20′ and printing machine control system

29 Arrow: transport direction

What is claimed is:

1. A method of setting register in a multicolor printing machine (1) having a number of items of equipment (2, 2′, . . . ) for the digital production of color separations (3, 3′, . . . ), the actions of setting up and combining the color separations (3, 3′, . . . ) being controlled, for the purpose of setting the register, in such a way that in-register prints are achieved, wherein in the event of a change in the toner profile, the influence of the toner profile on the register is taken into account, by means of available influencing variables (4, 4′, . . . ) directly as the change is implemented.

2. The method as claimed in claim 1, wherein in the event of a register correction resulting from a change in the toner profile, the retroactive influence (4) of the toner profile of the printing pages (5) which have gone before but are still in the printing process on the register of the new printed pages (5′) that are already in the printing process is taken into account.

3. The method as claimed in claim 2, wherein the influencing variables (4, 4′, . . . ) of the toner profiles are taken into account on the basis of stored values (6, 6′, . . . ) based on experience.

4. The method as claimed in one of claim 3, wherein the action of taking the influencing variables (4, 4′, . . . ) of the toner profiles into account is activated by a manual input.

5. The method as claimed in one of claim 3, wherein the influencing variables (4, 4′, . . . ) of the toner profiles are taken into account on the basis of the evaluation of digital image data (17).

6. The method as claimed in one of claim 3, wherein the influencing variables (4, 4′, 4″) are taken into account by automatically detecting the toner profiles.

7. The method as claimed in one of claim 6, wherein the influencing variables (4, 4′, . . . ) of various toner profiles are determined in accordance with the extent of area coverage of the total image area by the color separations (3, 3′, . . . ).

8. The method as claimed in one of claim 7, wherein it is used to correct a register control system which is based on detecting register marks (7, 7′, . . . ) which are printed by the individual printing units (8, 8′, . . . ), this correction being made before a change in the toner profile can have any influence on the register marks (7, 7′, . . . ).

9. The method as claimed in one of claim 8, wherein it is used to correct a register control system that is based on detecting the positions of the elements (9, 9′, . . . ; 10, 10′, . . . ; 11) which carry the color separations and substrate.

10. The method as claimed in one of claim 9, wherein further influencing variables, which have an influence on the register, are taken into account when setting the register.

11. Apparatus for implementing a method as claimed in one of claim 10 with a multicolor printing machine (1) having a number of items of equipment (2, 2′, . . . ) for the digital production of color separations (3, 3′, . . . ), at least one controller (12, 12′, . . . ), in order to achieve in-register prints, performing a register setting in which the actions of producing and combining the color separations (3, 3′, . . . ) are controlled, wherein the at least one controller (12, 12′, . . . ) is designed in such a way that in the event of a change in the toner profile, the influence of the toner profile on the register is taken into account, by means of available influencing variables (4, 4′, . . . ) directly as the change is implemented.

12. The apparatus as claimed in claim 11, wherein the at least one controller (12, 12′, . . . ) is designed in such a way that in the event of a register correction resulting from a change in the toner profile, the retroactive influence (4) of the toner profile of the printed page (5) which has gone before but is still in the printing process on the register of the new printed page (5′) that is already in the printing process is taken into account.

13. The apparatus as claimed in claim 12, wherein it is equipped with at least one memory (13, 13′, . . . ), which contains stored values (6, 6′, . . . ) based on experience of influencing variables (4, 4′, . . . ) of various toner profiles, the at least one controller (12, 12′, . . . ) controlling the actions of producing and combining the color separations (3, 3′, . . . ) on the basis of these values (6, 6′, . . . ) based on experience.

14. The apparatus as claimed in one of claim 13, wherein it is equipped with an input device (14) via which the influencing variables (4, 4′, . . . ) to be taken into account of various toner profiles can be activated manually.

15. The apparatus as claimed in one of claim 14, wherein a printing machine control system (15) is provided, which contains stored data from print jobs (21), and influencing variables (4, 4′, . . . ) of various toner profiles are taken into account on the basis of this data (21).

16. The apparatus as claimed in one of claim 15, wherein it is equipped with a device (20, 20′) for the automatic detection of the influencing variables (4, 4′, . . . ) of various toner profiles.

17. The apparatus as claimed in claim 16, wherein the device (20, 20′) for determining the influencing variables (4, 4′, . . . ) detects the toner profiles in accordance with the extent of area coverage of the total image area by the color separations (3, 3′, . . . ).

18. The apparatus as claimed in claim 17, wherein the device (20) is designed to detect the influencing variables (4, 4′, . . . ) from the digital image data (17).

19. The apparatus as claimed in claim 18, wherein during the evaluation of the digital image data (17), areas with a number of image pixels are combined.

20. The apparatus as claimed in one of claim 19, wherein the at least one controller (12, 12′, . . . ) is designed in such a way that it controls the register by means of detecting register marks (7, 7′, . . . ) which are printed by the individual printing units (8, 8′, . . . ) and detected by a register sensor (18), and takes into account the influencing variables (4, 4′, . . . ) of the toner profiles as correction factors, the correction being made before a change in the toner profile can have any influence on the register marks (7, 7′, . . . ).

21. The apparatus as claimed in one of claim 20, wherein the at least one controller (12, 12′, . . . ) is designed in such a way that it controls the register by means of detecting the positions of the elements (9, 9′, . . . ; 10, 10′, . . . ; 11) that carry the color separations and substrate by means of position detecting elements (19), and takes into account the influencing variables (4, 4′, . . . ) of the toner profiles as correction factors.

22. The apparatus as claimed in one of claim 21, wherein the at least one controller (12, 12′, . . . ) is designed in such a way that, when setting the register, it takes into account further influencing variables which have an influence on the register.
